(19) United States
(12) Patent Application Publication
(10) Pub. No.: US 2007/0242177 A1
(43) Pub. Date: Oct. 18, 2007

(54) Optical filter for display apparatus

(75) Inventors: Jang Hoon Lee, Gyeongsangbuk-do (KR); Je Choon Ryoo, Daegu (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SAMSUNG CORNING CO., LTD., Suwon-si (KR)

(21) Appl. No.: 11/784,147

(22) Filed: Apr. 5, 2007

(30) Foreign Application Priority Data
Apr. 5, 2006 (KR) KR1020060031102

(51) Int. Cl. G02F 1/136

(52) U.S. Cl. 349/42

(57) ABSTRACT

An optical filter for a display apparatus in which the thickness is reduced and reliability for an EM radiation emission path is improved is provided. The optical filter for the display apparatus includes: a transparent support substrate being formed with a conductive coating film on one surface of the transparent support substrate; an optical film comprising a transparent base substrate formed in a single layer, an antireflective layer formed on one surface of the base substrate, and an adhesive layer formed on the other surface of the base substrate, in which the optical film is attached onto the conductive coating film to expose a surrounding portion of the conductive coating film by the adhesive layer; and a conductive electrode contacting with an exposed area of the conductive coating film.

### CROSS-REFERENCE TO RELATED APPLICATION

This application claims the benefit of Korean Patent Application No. 10-2006-0031102, filed on Apr. 5, 2006, in the Korean Intellectual Property Office, the disclosure of which is incorporated herein by reference.

### BACKGROUND OF THE INVENTION

1. Field of the Invention

The present invention relates to an optical filter for a display apparatus, and more particularly, to an optical filter for a display apparatus having an electromagnetic (EM) radiation shielding function.

2. Description of Related Art

As modern society becomes more information oriented, technology of parts and devices related to image displays is remarkably advancing, and these parts and devices are becoming widespread. Display apparatuses utilizing parts and devices related to photoelectronics are becoming significantly widespread and used for television apparatuses, monitor apparatuses of personal computers, and the like.

Cathode-ray tube (CRT) apparatuses represent existing display apparatuses. However, the CRT apparatuses may not sufficiently satisfy a trend of becoming larger and of becoming thinner. Therefore, flat display apparatuses are being actively studied as next-generation display apparatuses. Examples of the flat display apparatuses include plasma display panel (PDP) apparatuses, plasma address liquid crystal display panel (PALC) apparatuses, field emission display (FED) apparatuses, liquid crystal display (LCD) apparatuses, organic electroluminescence (EL) display apparatuses, and the like. Among the flat display apparatuses, PDP apparatuses have an excellent viewing angle and also may be readily manufactured in a thin and large size, and thus are gaining popularity. Particularly, CRT apparatuses are disappearing in a market of large television field.

When a high voltage is supplied to a gas, a gas discharge is generated between electrodes. The PDP apparatus displays an image by using the generated gas discharge. Here, since the high voltage is supplied, electromagnetic (EM) radiation harmful to humans, near infrared (NI) radiation causing remote controllers, and the like, to malfunction, neon light causing a detrimental effect on color purity due to orange light emitted from the neon light, and the like, are generated.

To shield EM radiation, NI radiation, neon light, and the like, an optical filter for a display apparatus is provided in front of the PDP apparatus. In this instance, the optical filter for the display apparatus includes an optical layer having an EM radiation-shielding function, an NI radiation-shielding function, and a color correcting function. However, when providing a plurality of optical films, each of which includes the optical layer with the above-described functions, the optical filter becomes thicker, which is opposite to the trend that the display apparatus becomes thinner. Also, a manufacturing process becomes complex. Accordingly, there is a need for an optical filter that can be made thinner by reducing a number of optical films.

Also, in the case of the optical layer having the EM radiation-shielding function, when EM radiation is not emitted to a ground from a display apparatus, or the emission is delayed, the optical layer functions as an antenna and thus may externally emit the EM radiation. Accordingly, there is a need for a path capable of readily emitting EM radiation.

### BRIEF SUMMARY

An aspect of the present invention provides an optical filter for a display apparatus in which the thickness of the optical filter is reduced, and a reliability for an EM radiation emitting path is improved.

Technical solutions of the present invention are not limited to the above technical solutions, and other technical solutions which are not described would be definitely appreciated from a description below by those skilled in the art.

According to an aspect of the present invention, there is provided an optical filter for a display apparatus, including: a transparent support substrate being formed with a conductive coating film on one surface of the transparent support substrate; an optical film comprising a transparent base substrate formed in a single layer, an antireflective layer formed on one surface of the base substrate, and an adhesive layer formed on the other surface of the base substrate, in which the optical film is attached onto the conductive coating film to expose a surrounding portion of the conductive coating film by the adhesive layer; and a conductive electrode contacting with an exposed area of the conductive coating film.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a top view illustrating an optical filter for a display apparatus according to an exemplary embodiment of the present invention;

FIG. 2 is a cross-sectional view illustrating an optical filter cut along a line II-II′ of FIG. 1;

FIG. 3 is a cross-sectional view illustrating a conductive coating film according to an exemplary embodiment of the present invention;

FIG. 4 is a cross-sectional view illustrating an optical film according to an exemplary embodiment of the present invention;

FIG. 5 is an enlarged view illustrating an area A of FIG. 2;

FIG. 6 is a cross-sectional view illustrating an optical filter for a display apparatus according to another exemplary embodiment of the present invention; and

FIG. 7 is a cross-sectional view illustrating an optical filter for a display apparatus according to still another exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Spatially relative terms, such as “below”, “beneath”, “lower”, “above”, “upper”, and the like, may be used herein for ease of description to describe one element or feature's relationship to another element(s) of feature(s) as illustrated in the figures. It will be understood that the spatially relative terms are intended to encompass different orientations of the device in use or operation in addition to the orientation depicted in the figures. For example, if the device in the figures is inverted, elements described as “below” or “beneath” other elements or features would then oriented “above” the other elements or features. Thus, the exemplary term “below” can encompass both an orientation of “above” and “below”. The device may be otherwise oriented and the spatially relative terms used herein may be interpreted accordingly.

An optical filter for a display apparatus according to the present invention may be provided in front of a display apparatus and thereby used. For example, the optical filter for the display apparatus may be applied to a flat display apparatus, such as a plasma display panel (PDP) apparatus, a plasma address liquid crystal display panel (PALC) apparatus, a field emission display (FED) apparatus, a cathode-ray tube (CRT) apparatus, and the like. The optical filter for the display apparatus may be utilized for the PDP apparatus. However, it is only an example and thus the present invention is not limited thereto. Specifically, it will be apparent to those of ordinary skills in the art that the present invention may be applied to various types of display apparatuses requiring an EM radiation-shielding function, and the like.

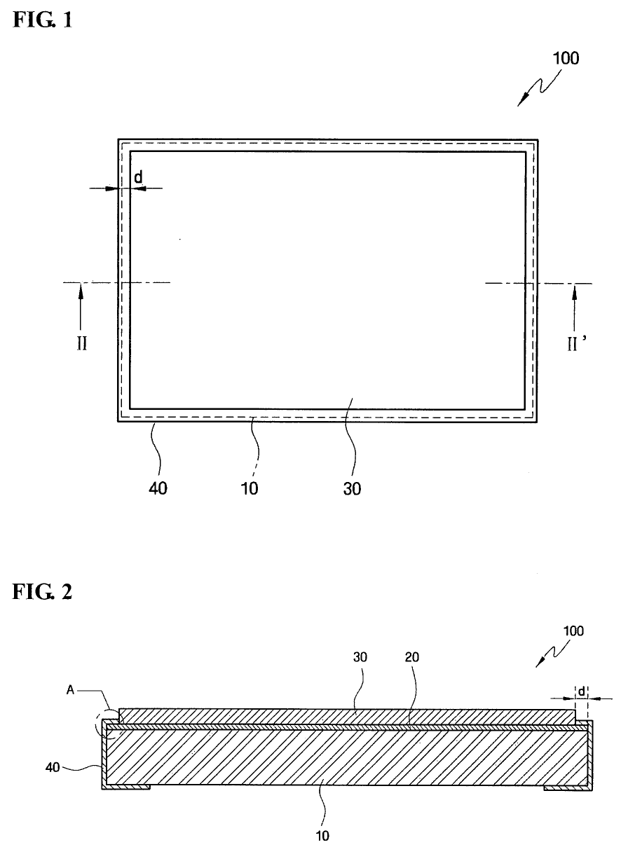

Hereinafter, an optical filter for a display apparatus according to an exemplary embodiment of the present invention will be described. FIG. 1 is a top view illustrating an optical filter for a display apparatus 100 according to an exemplary embodiment of the present invention, and FIG. 2 is a cross-sectional view illustrating the optical filter 100 cut along a line II-II′ of FIG. 1

Referring to FIGS. 1 and 2, the optical filter for the display apparatus 100 includes a support substrate 10, a conductive coating film 20 formed on the support substrate 10, an optical film 30 attached onto the conductive coating film 20, and a conductive electrode 40 contacting with the conductive coating film 20.

The support substrate 10 functions to support the conductive coating film 20, the optical film 30, and the like. Also, the support substrate 10 is formed in a substantially identical shape as a display screen of the display apparatus. For example, when the display screen of the display apparatus is formed in a rectangular shape, the support substrate 10 also may be formed in the rectangular shape.

The support substrate 10 includes a transparent material to negligibly reduce brightness of the display apparatus. For example, a glass substrate with excellent transparency, polyethylene terephthalate (PET), polyvinyl alcohol, polycarbonate (PC), acrylic resin, and the like, may be utilized for the support substrate 10. Since the glass substrate has a sufficient strength and also can endure a high temperature during a process of providing the conductive coating film 20, which will be described later, the glass substrate may be utilized for the support substrate 10. Also, a tempered glass substrate may be utilized to have a sufficient strength for a large surface.

The support substrate 10 is manufactured to have a size capable of covering the entire display screen of the display apparatus. For example, when the display apparatus has a 42-inch display screen, the support substrate 10 may have the size of about 984 mm×about 584 mm. Also, the substrate support 10 may have a different thickness depending on a material or size of the support substrate 10. For example, when the support substrate 10 is formed of glass and has the size of about 984 mm×about 584 mm, the thickness of the support substrate 10 may be within the range of about 2.5 mm to about 3.5 mm.

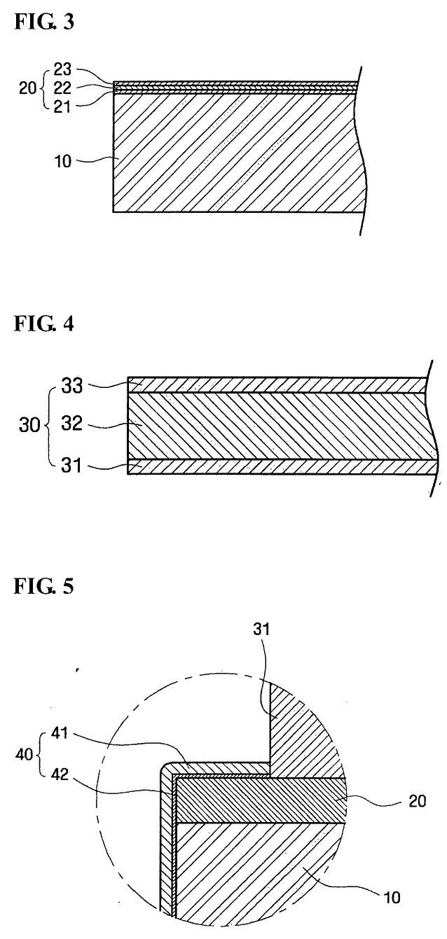

The conductive coating film 20 functions to shield EM radiation and/or NI radiation emitted from the display apparatus. Also, the conductive coating film 20 is provided on the support substrate 10. In this instance, the conductive coating film 20 may include a single layer. Also, the conductive coating film 20 may be formed in a multi-layer structure including at least two layers. The structure of the conductive coating film 20 will be described in detail with reference to FIG. 3.

FIG. 3 is a cross-sectional view illustrating the conductive coating film 20 according to an exemplary embodiment of the present invention. As shown in FIG. 3, the conductive coating film 20 includes a conductive thin layer 22 and a plurality of transparent thin layers with a high refractive index 21 and 23.

The conductive thin layer 22 absorbs EM radiation emitted from the display apparatus, and absorbs or reflects NI radiation emitted from the display apparatus, and thereby prevents emission of the EM radiation and the NI radiation. In this instance, since silver (Ag) has an excellent conductivity and a comparatively high visible ray transmittance, silver may be utilized for material of the conductive thin layer 22. Also, for physical and chemical stability of the conductivity thin layer 22, a silver-based alloy may be utilized. The silver-based alloy is acquired by mixing silver with at least one selected from the group consisting of gold, platinum, palladium, copper, indium, tin, and the like. In this instance, the thickness of the conductive thin layer 22 may be within the range of about 4 nm to about 30 nm.

The transparent thin layers with the high refractive index 21 and 23 increase transparency in a visible spectrum, and decrease refraction of the visible light. Specifically, when comparing with providing only the conductive thin layer 22, the entire visible light transmittance may be increased by alternatingly providing the transparent thin layers with the high refractive index 21 and 23, and the conductive thin layer 22. In this instance, a material with the refractive index greater than about 1.6 may be utilized for the transparent thin layers with the high refractive index 21 and 23. For example, the material may include an oxide such as niobium indium, titanium, zirconium, bismuth, and tin, or mixtures thereof. Also, preferably, niobium pentoxide (Nb₂O₅), indium tin oxide (ITO), and the like, may be utilized for the material. In this instance, the thickness of each of the transparent thin layers with the high refractive index 21 and 23 may be within the range of about 5 nm to 200 nm.

As shown in FIG. 3, the conductive thin layer 22 and the transparent thin layers with the high refractive index 21 and 23 may be alternatingly stacked. The stacking operation may be performed, preferably, at least twice. Also, another layer, for example, an aluminum zinc oxide (AZO) thin layer may be provided among the conductive thin layer 22 and the transparent thin layers with the high refractive index 21 and 23.

The conductive thin layer 22 and the transparent thin layers with the high refractive index 21 and 23 may be directly coated on the support substrate 10 by a deposition scheme using sputtering. In this instance, the sputtering is performed in the temperature greater than or equal to, for example, about 100° C. When the support substrate 10 is formed of glass, the conductive thin layer 22 and the transparent thin layers with the high refractive index 21 and 23 may be reliably coated even at the above temperature.

Also, the conductive thin layer 22 may be coated on another base substrate and thereby attached onto the support substrate 10. However, as described above, the thickness of the optical filter 100 may be reduced by directly coating the conductive thin layer 22 on the support substrate 10. Also, when the other base substrate and an adhesive layer are provided, a number of material interfaces increases and thus reflectivity may increase. However, when the conductive thin layer 22 is directly coated on the support substrate 10, an additional bonding process may be omitted and thus a manufacturing process may be simplified. Also, a manufacturing cost may be reduced.

Referring again to FIGS. 1 and 2, the optical film 30 is provided on the conductive coating film 20. In this instance, the optical film 30 has a color correction function and/or a reflection preventing function, and may be formed in a multi-layer structure. The structure of the optical film 30 will be described in detail with reference to FIG. 4.

FIG. 4 is a cross-sectional view illustrating the optical film 30 according to an exemplary embodiment of the present invention. As shown in FIG. 4, the optical film 30 includes a transparent base substrate 32 formed in a single layer, an antireflective layer 33 formed on one surface of the base substrate 32, and an adhesive layer 31 formed on the other surface of the base substrate 32.

The base substrate 32 functions to support the antireflective layer 33, and may include a material with excellent transparency. In this instance, the base substrate 32 is supported by the support substrate 10, and thus the base substrate 32 does not need as much strength as the support substrate 10. Also, when the base substrate 32 is provided on the support substrate 10 by a roll-to-roll process, a material of the base substrate 32 may include PET, polyvinyl alcohol, PC, triacetyl cellulose (TAC), acrylic resin, and the like. In this instance, preferably, PET may be utilized for the material.

The antireflective layer 33 functions to prevent a reflection of external light and thereby improve a screen quality. Also, the antireflective layer 33 may include a material with a refractive index less than about 1.5 in a visible spectrum, for example, a fluorine-based transparent polymeric resin, a silicon-based resin, silicon oxide, acrylic resin, and the like. In this instance, at least two layers including above materials may be provided. In addition to the material with the low refractive index, the antireflective layer 33 may further include a material having other optical characteristics. Also, a preventive layer (not shown) or other functional layers may be further provided on the antireflective layer 33.

The antireflective layer 33 may be directly coated on the base substrate 32.

The adhesive layer 31 functions to provide the optical film 30 on the support substrate 10. Specifically, the adhesive layer 31 is formed on the other surface of the base substrate 32 and thus is attached onto the conductive coating film 20 formed on the support substrate 10. The adhesive layer 31 may include a binder resin and a pressure sensitive adhesive including an adhesive resin and a bridging agent. Also, the adhesive layer 31 may further include a color correction colorant and thereby perform a color correction function. In this instance, an additional base substrate is not required and thus the thickness of the optical filter 100 may be reduced.

As described above, the optical film 30 has a size less than the support substrate 10 for ease of an adhesion process, reliability of adhesiveness, and the like. Therefore, as shown in FIGS. 1 and 2, the optical film 30 has the size less than the conductive coating film 20 having the same size as the support substrate 10, and exposes at least one portion of a surrounding portion of the conductive coating film 20. When the conductive coating film 20 is formed in a rectangular shape, a uniform width d may be exposed from each side. For example, when the size of the support substrate 10 is about 984×584 mm², the size of the optical film 30 may be about 976×576 mm². In this instance, the exposed area may have a uniform width d of about 4 mm.

The thickness of the optical film 30 may be within the range of, for example, about 0.06 mm to about 0.6 mm.

The exposed area of the conductive coating film 20 contacts with the conductive electrode 40, and thereby discharges to ground EM radiation absorbed in the conductive coating film 20. The conductive electrode 40 is extended from the exposed area of the conductive coating film 20 along a sidewall of the support substrate 10 and the other surface of the support substrate 10 connected to the sidewall. The conductive electrode 40 may be attached onto the exposed area of the conductive coating film 20, the sidewall of the support substrate 10, and the other surface of the support substrate 10. FIG. 5 is an enlarged view illustrating an area A of FIG. 2. As shown in FIG. 5, the conductive electrode 40 may include a copper layer 41 with excellent conductivity and a conductive adhesive layer 42. However, the present invention is not limited thereto. Specifically, copper powders or silver powders may be attached onto the conductive electrode 40 in a form of a paste. Also, in addition to the copper layer 41, a silver layer may be utilized.

The conductive electrode 40 constructed as above connects with a ground unit (not shown) of the display apparatus on the other surface of the support substrate 10. Accordingly, the emission path of EM radiation, emitted from the display apparatus, passes through the conductive electrode 40 and the ground unit of the display apparatus from the conductive coating film 20.

In an aspect of reliability for adhesiveness of an optical film, when at least two optical films are provided, the size of one optical film provided in an upper portion is smaller than the size of the other optical film provided in a lower portion. Also, when the conductive coating film 20 is provided on another base substrate, the size of the other base substrate is less than the size of the support substrate 10. For example, a first base substrate, formed with a conductive coating film, to be attached onto the support substrate 10 with the size of about 984×584 mm², may have the size of about 982×584 mm². In this instance, assuming that the size of a second base substrate provided on the first base substrate is identical to the size of the adhesive layer 31 corresponding to the base substrate, for example, about 976×576 mm², according to an exemplary embodiment of the present invention, a contact width between the conductive coating film 20 and the conductive electrode 40 is about 3 mm. Specifically, the contact width is reduced by about 1 mm from about 4 mm to about 3 mm. Also, a contact area is reduced by about 31.3 cm².

The contact area between the conductive coating film 20 and the conductive electrode 40 corresponds to a factor associated with contact reliability and reliability for an EM radiation emission path. Therefore, according to the present exemplary embodiment, the contact reliability and the reliability for the EM radiation emission path may be readily improved.

Hereinafter, an optical filter for a display apparatus according to another exemplary embodiment of the present invention will be described. In the present exemplary embodiment, elements identical to the above-described exemplary embodiment will be omitted or described briefly. Only the differences therebetween will be described.

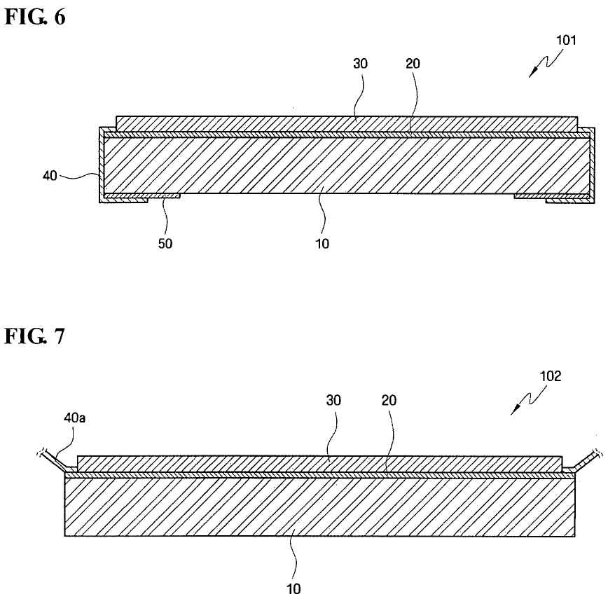

FIG. 6 is a cross-sectional view illustrating an optical filter for a display apparatus 101 according to another exemplary embodiment of the present invention.

Referring to FIG. 6, the optical filter for the display apparatus 101 further includes a black ceramic pattern 50. The black ceramic pattern 50 is formed along the surrounding portion of the other surface of the support substrate 10 to be overlapped with the optical film 30. The black ceramic pattern 50 makes an external frame area of a display area of the display apparatus be displayed in black, and thus an image may comparatively stand out. The black ceramic pattern 50 may be formed of glass, and the like, including, for example, black pigment. Also, the conductive electrode 40 according to the present exemplary embodiment is extended from the exposed area of the surrounding portion of the conductive coating film 20 along the sidewall of the support substrate 10, which is the same as the above-described exemplary embodiment of the present invention. However, in the present exemplary embodiment, the conductive electrode 40 is provided on the black ceramic pattern 50 on the other surface of the support substrate 10.

FIG. 7 is a cross-sectional view illustrating an optical filter for a display apparatus 102 according to still another exemplary embodiment of the present invention. In the present exemplary embodiment, elements identical to the above-described exemplary embodiment will be omitted or described briefly. Only the differences therebetween will be described.

Referring to FIG. 7, in the optical filter for the display apparatus 102, a conductive electrode 40a contacts with the exposed area of the conductive coating film 20, which is the same as the above-described exemplary embodiments. However, in the present exemplary embodiment, the conductive electrode 40a is extended towards an upper portion, not along the sidewall of the support substrate 10. Specifically, when a ground unit is provided to a cover (not shown) positioned in front of the display apparatus, the conductive electrode 40a may be extended towards the upper portion and thereby directly contact with the ground unit. In this instance, it will be apparent to those of ordinary skills in the art that a contact area between the conductive coating film 20 and the conductive electrode 40a may be sufficiently secured similar to the above-described exemplary embodiments.

As described above, according to the present invention, there is provided an optical filter for a display apparatus which can reduce a number of optical films by directly coating a conductive coating film on a support substrate, and thereby can reduce the thickness of the optical filter and control the increase of reflectivity. Also, a manufacturing process may be simplified and manufacturing cost may be reduced.

Also, according to the present invention, there is provided an optical filter for a display apparatus which can secure a sufficient contact area between a conductive electrode and a conductive coating film and thereby improve the reliability for an EM radiation emission path.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed:

1. An optical filter for a display apparatus, comprising:
a transparent support substrate being formed with a conductive coating film on one surface of the transparent support substrate;
an optical film comprising a transparent base substrate formed in a single layer, an antireflective layer formed on one surface of the base substrate, and an adhesive layer formed on the other surface of the base substrate, in which the optical film is attached onto the conductive coating film to expose a surrounding portion of the conductive coating film by the adhesive layer; and
a conductive electrode contacting with an exposed area of the conductive coating film.

2. The optical filter of claim 1, wherein the conductive coating film is directly coated on the support substrate.

3. The optical filter of claim 1, wherein a width of the exposed area of the conductive coating film is greater than or equal to about 4 mm.

4. The optical filter of claim 1, wherein the conductive electrode is extended from the exposed area of the conductive coating film along a sidewall of the support substrate and the other surface of the support substrate connected to the sidewall.

5. The optical filter of claim 4, wherein the conductive electrode comprises a copper layer and a conductive adhesive layer, and the conductive electrode is attached onto the exposed area of the conductive coating film, a sidewall of the support substrate, and the other surface of the support substrate.

6. The optical filter of claim 5, wherein the adhesive layer includes a color correction colorant.

7. The optical filter of claim 1, wherein the conductive coating film includes at least one conductive thin layer and at least one transparent thin layer with a high refractive index.

8. The optical filter of claim 7, wherein the conductive thin layer includes silver (Ag) or a silver-based alloy, and the transparent thin layer with a high refractive index includes niobium oxide.

9. The optical filter of claim 1, further comprising:
a black ceramic pattern being formed along the surrounding portion of the other surface of the support substrate to be overlapped with the optical film.

10. The optical film of claim 1, wherein the support substrate includes a tempered glass.
